(19) United States
(12) Patent Application Publication
(10) Pub. No.: US 2026/0162295 A1
(43) Pub. Date: Jun. 11, 2026

(54) REAL-TIME POSITION TRACKING SYSTEM AND METHOD

(71) Applicant: KOREA ELECTRONICS TECHNOLOGY INSTITUTE, Seongnam-si (KR)

(72) Inventors: Suk Woo JUNG, Suwon-si (KR); Youn Sung LEE, Seoul (KR); Hyun Sik KIM, Seongnam-si (KR)

(21) Appl. No.: 19/411,907

(22) Filed: Dec. 8, 2025

(30) Foreign Application Priority Data
Dec. 9, 2024 (KR) 10-2024-0181675

(51) Int. Cl. G06T 7/70; G06T 7/20; G06T 7/579; G06V 10/74

(52) U.S. Cl. CPC G06T 7/70; G06T 7/20; G06T 7/579; G06V 10/761

(57) ABSTRACT

A real-time position tracking system and method can accurately track a position in real time by utilizing spatial information and images acquired in advance. The system may include a reference database configured to store reference images captured at a plurality of locations within a designated space. The system may also include a real-time data acquisition module configured to acquire a real-time image while moving within the designated space. The system may further include a position estimation module configured to estimate current position information by comparing the real-time image acquired by the real-time data acquisition module with the reference images stored in the reference database.

### CROSS REFERENCE TO RELATED APPLICATION

The present application claims priority to Korean Patent Application No. 10-2024-0181675 filed on Dec. 9, 2024 in the Korean Intellectual Property Office, the entire contents of which are incorporated herein for all purposes by this reference.

### BACKGROUND

### Technical Field

The present disclosure relates to a real-time position tracking technique, and more particularly, to a real-time position tracking system and method capable of accurately tracking a position in real time by utilizing spatial information and images acquired in advance.

### Description of Related Technology

Simultaneous localization and mapping (SLAM) technology utilizes sensors to collect three-dimensional (3D) spatial information and, based on this, creates a map of the surrounding environment while estimating the real-time position of a camera or robot.

### SUMMARY

One aspect is a real-time position tracking system and method that enable accurate and fast real-time position tracking by utilizing images acquired in advance.

Another aspect is a real-time position tracking system that includes a reference database configured to store reference images captured at a plurality of locations within a designated space, a real-time data acquisition module configured to acquire a real-time image while moving within the designated space, and a position estimation module configured to estimate current position information by comparing the real-time image acquired by the real-time data acquisition module with the reference images stored in the reference database.

In an embodiment, the reference database may further store map data for the designated space.

In an embodiment, the map data may be acquired through three-dimensional (3D) scanning.

In an embodiment, the reference images may be captured from multiple angles at the plurality of locations with specified intervals within the designated space.

In an embodiment, the reference images may be mapped respectively to the locations within the designated space and stored in a lookup table form.

In an embodiment, the real-time data acquisition module may include a stereo camera.

In an embodiment, the position estimation module may include a similar image retriever configured to retrieve an image most similar to the real-time image among the reference images, a transformation matrix calculator configured to calculate a transformation matrix based on a difference between the reference image retrieved by the similar image retriever and the real-time image, and a position estimator configured to estimate the current position information by applying the transformation matrix to a position of the reference image retrieved by the similar image retriever.

In an embodiment, the similar image retriever may match feature points of the real-time image and each reference image to retrieve the image most similar to the real-time image among the reference images.

In an embodiment, the system may further include a simultaneous localization and mapping (SLAM) position estimation module configured to acquire relative position information through SLAM technique using data acquired from the real-time data acquisition module.

In an embodiment, the system may further include a position correction module configured to correct the current position information estimated by the position estimation module, using the relative position information acquired by the SLAM position estimation module.

In an embodiment, the position correction module may correct the current position information through Kalman filtering.

Another aspect is a real-time position tracking method that includes creating and storing reference images captured at a plurality of locations within a designated space; by a real-time data acquisition module, acquiring a real-time image while moving within the designated space; and by a position estimation module, estimating current position information by comparing the acquired real-time image with the created and stored reference images.

According to the real-time position tracking system and method the present disclosure, it is possible to estimate the position of the object in real time with high precision during the object's movement.

In conventional SLAM position estimation, it is difficult to accurately calculate the absolute coordinates of the moving object due to the calculation of the relative position based on the starting location of the object. However, the present disclosure makes it possible to accurately calculate the absolute coordinates of the moving object by using the absolute coordinates of the reference image.

### BRIEF DESCRIPTION OF THE DRAWINGS

FIG. 1 is a schematic diagram of a real-time position tracking system according to an embodiment of the present disclosure.

FIG. 2 is a diagram illustrating the operation of a real-time position tracking system according to an embodiment of the present disclosure.

FIG. 3 is an exemplary view of map data stored in a reference database of a real-time position tracking system according to an embodiment of the present disclosure.

FIG. 4 is a schematic diagram of a real-time position tracking system according to another embodiment of the present disclosure.

FIG. 5 is a diagram illustrating the operation of a real-time position tracking system according to another embodiment of the present disclosure.

FIG. 6 is a flowchart of a real-time position tracking method according to an embodiment of the present disclosure.

FIG. 7 is a flowchart of a real-time position tracking method according to another embodiment of the present disclosure.

### DETAILED DESCRIPTION

Traditionally, SLAM has been performed in combination with various sensors, such as LiDAR, camera, GPS, and inertial measurement unit (IMU). However, existing technologies have the following limitations.

First, SLAM technology tracks a moving object's path and calculates its relative position based on its starting location. This may lead to decreased accuracy in estimating the object's absolute coordinates within the 3D map over the long term. Particularly in complex or large spaces, accumulated errors make it difficult to pinpoint the precise location of an object.

Second, because the position is estimated by recognizing environmental information around the object in real time, even slight changes in the environment can lead to inconsistencies with the accumulated data, making accurate position estimation difficult. Consequently, SLAM has limitations in determining absolute coordinates in indoor or outdoor spaces where a consistent environment is not maintained.

Now, embodiments of the present disclosure will be described in detail with reference to the accompanying drawings. However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

In addition, the terms used herein are only examples for describing a specific embodiment and do not limit various embodiments of the present disclosure. The singular expressions may include plural expressions unless the context clearly dictates otherwise. Also, the terms “comprise”, “include”, “have”, and derivatives thereof refer to inclusion without limitation. That is, these terms are intended to specify the presence of features, numerals, steps, operations, elements, components, or combinations thereof, which are disclosed herein, and should not be construed to preclude the presence or addition of other features, numerals, steps, operations, elements, components, or combinations thereof.

The terms such as “unit” and “module” used herein refer to a unit that processes at least one function or operation and may be implemented with hardware, software, or a combination of hardware and software. In addition, the terms “a”, “an”, “one”, “the”, and similar terms are used herein in the context of describing the present disclosure (especially in the context of the following claims) may be used as both singular and plural meanings unless the context clearly indicates otherwise.

Further, when it is stated that a certain element is “coupled to” or “connected to” another element, the element may be logically, operatively, electrically, or physically coupled or connected to another element. That is, the element may be directly coupled or connected to another element, or a new element may exist between both elements.

Also, embodiments within the scope of the present disclosure include computer-readable media having computer-executable instructions or data structures stored on computer-readable media. Such computer-readable media can be any available media that is accessible by a general purpose or special purpose computer system. By way of example, such computer-readable media may include, but not limited to, RAM, ROM, EPROM, CD-ROM or other optical disk storage, magnetic disk storage or other magnetic storage devices, or any other physical storage medium that can be used to store or deliver certain program codes formed of computer-executable instructions, computer-readable instructions or data structures and which can be accessed by a general purpose or special purpose computer system.

Hereinafter, a real-time position tracking system and method according to the present disclosure will be described.

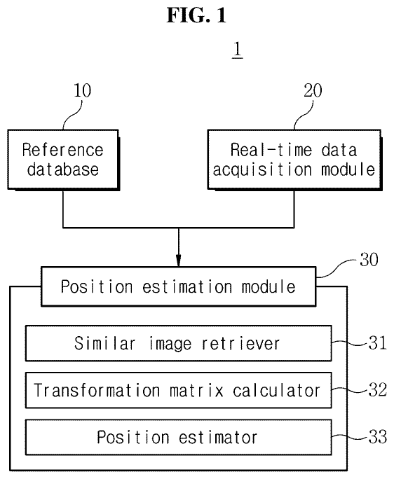

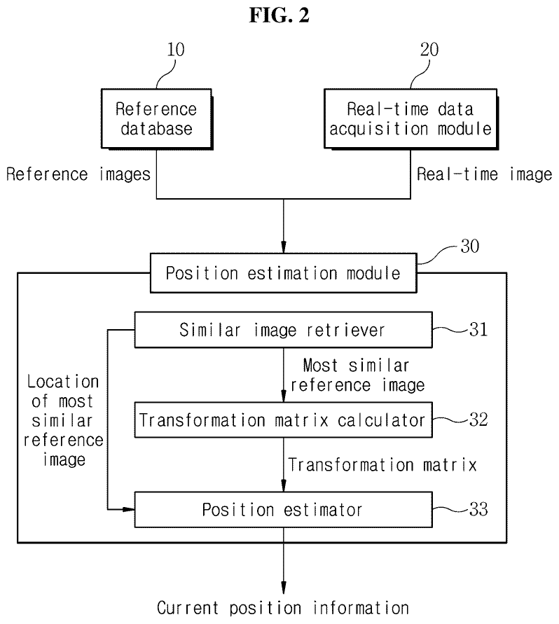

FIG. 1 is a schematic diagram of a real-time position tracking system according to an embodiment of the present disclosure, and FIG. 2 is a diagram illustrating the operation of a real-time position tracking system according to an embodiment of the present disclosure.

The real-time position tracking system 1 according to an embodiment of the present disclosure includes a reference database 10, a real-time data acquisition module 20, and a position estimation module 30, and is characterized by performing high-precision position estimation in real time.

The reference database 10 is a repository of prior data for real-time position estimation and stores reference images captured at a plurality of locations within a designated space. The reference images visually represent corresponding locations and are used as a basis for comparison with real-time data. The reference images may be stored in association with data regarding locations (absolute coordinates) within the designated space. In other words, the reference database 10 provides essential reference data for estimating the current position through comparison with real-time data.

The reference database 10 may further store map data for the designated space. The map data represents the physical structure and topographical information of a predefined environment.

The real-time data acquisition module 20 is formed on a moving object, such as a robot or an unmanned vehicle, and is configured to acquire real-time images while the object moves within a designated space. The real-time data acquisition module 20 can acquire real-time images within the designated space through a device such as a camera. The real-time data acquisition module 20 can continuously collect data reflecting changes in the environment even while moving and transmit the collected data to the position estimation module 30. That is, the real-time data acquisition module 20 provides the current environmental data of the object in real time, which can be used to estimate the position through comparison and matching with the reference database 10.

The position estimation module 30 estimates the current position of an object by comparing the real-time image provided by the real-time data acquisition module 20 with the reference images stored in the reference database 10. Specifically, the position estimation module 30 can compare the real-time image with the reference images stored in the reference database 10 to retrieve the most similar reference image. Then, based on the position information of the retrieved reference image, the position estimation module 30 can calculate the current coordinates within the space where the real-time image is located.

According to the above-described real-time position tracking system 1, the reference database 10 provides high-precision reference data (reference images) to be compared with real-time data, and the real-time data acquisition module 20 collects the current environment information (real-time image) of the object in real time, thereby allowing for position estimation with high precision even while moving.

In conventional SLAM position estimation, it is difficult to accurately calculate the absolute coordinates of a moving object due to the calculation of the relative position based on the starting location of the object. However, the present disclosure makes it possible to accurately calculate the absolute coordinates of a moving object by using the absolute coordinates of a reference image.

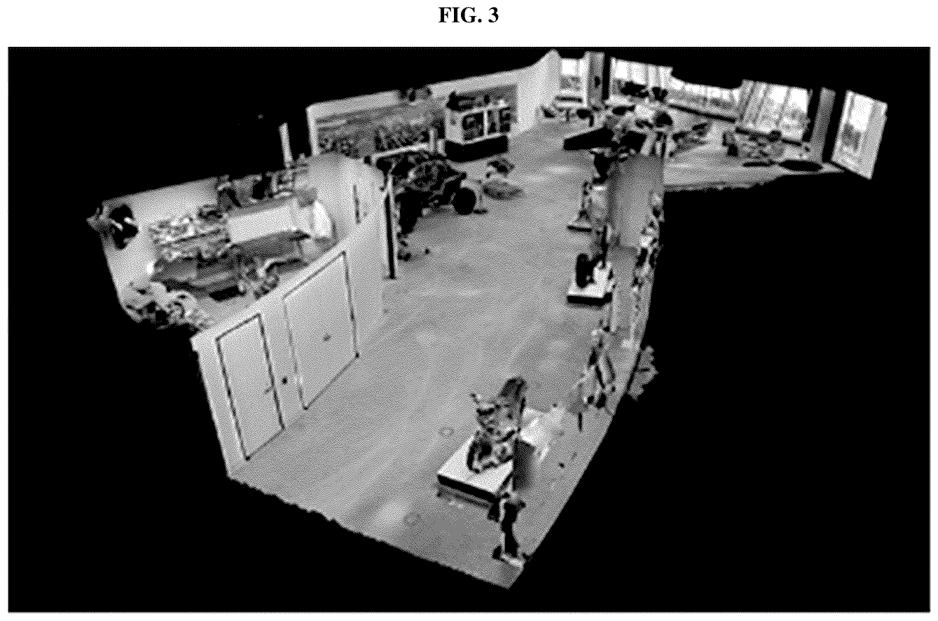

The map data stored in the reference database 10 may be acquired through 3D scanning. FIG. 3 illustrates an example of map data acquired through 3D scanning.

For example, the map data may be digitized by precisely capturing all physical structures of a designated space using 3D scanning equipment such as the RTC360. In general, 3D scanning technology can digitize the position and size of all elements within a space with high precision. The 3D map data generated through 3D scanning can represent the detailed topography and structure of a designated space, including stereoscopic environmental information that 2D data cannot provide.

Thus, the map data generated through 3D scanning can provide stereoscopic and detailed information about a space.

When 3D map data is used, the present disclosure can be effectively applied to extended reality (XR) environments such as the metaverse. The 3D map data can be utilized in the same manner in virtual space, enabling tracking of object locations and interaction within the virtual world. Furthermore, by matching 3D data acquired in real time with the virtual world, a continuous data flow between physical and virtual spaces can be established.

Alternatively, map data may also be two-dimensional. For example, the 2D map data can be created in the form of a floor plan. The 2D map data can be used to display the operating status of the real-time position tracking system according to the present disclosure, thereby enabling users to intuitively understand the status.

The reference images stored in the reference database 10 may be images captured at specified intervals and from various angles within a designated space.

For example, the reference images may be those captured at 1-meter intervals within the designated space. This interval setting systematically organizes the reference database 10, enabling efficient comparison with real-time data during the position estimation process. In other words, images captured at regular intervals reflect spatial continuity, enabling stable matching in comparison with real-time data even in the presence of environmental changes. Furthermore, the reference images captured at specified intervals can effectively encompass key points within the space.

For example, the reference images may be those captured at 60-degree intervals at each location within the designated space. Consequently, environmental information can be collected from various viewpoints within the 3D space, contributing to increased position estimation accuracy. In other words, images captured from multiple angles at each location provide diverse visual data even from the same location, increasing the likelihood of retrieving images with higher similarity in comparison with real-time data. Furthermore, the variety of shooting angles increases the probability of finding matching reference image/data, even when environmental changes affect the real-time data.

Capturing the reference images at specified intervals and various angles can optimize the performance of the template matching algorithm. Template matching refers to an algorithm that compares a real-time image with reference images to find the most similar image. Matching speed and accuracy are significantly affected by the organization scheme of the reference images. If the reference images are uniformly and comprehensively organized within the space, the matching algorithm can efficiently find the optimal image.

The reference images may be stored in the form of a lookup table. In this case, the stored reference images may be mapped to the locations where the images are captured. Also, the stored reference images may be mapped to the shooting angles.

The lookup table is a structure that systematically stores reference image data and may include information about the shooting locations and shooting angles of the reference images as entries. For example, each reference image is associated with specific coordinates, which represent the absolute location within the map data.

The lookup table provides a structure for systematic data retrieval, thereby reducing the amount of computation required for comparison with real-time data.

Furthermore, since the reference images are stored along with position and angle information through the lookup table structure, the current position information of an object can be estimated based on the comparison results with real-time data.

The real-time data acquisition module 20 may include a stereo camera.

The stereo camera is a device that uses two lenses to measure depth and distance information of an object and simultaneously acquires 2D images and 3D data. The 2D images acquired by the stereo camera can be used to estimate the current position through comparison with the reference images. The 3D data can be utilized to calculate relative position information using simultaneous localization and mapping (SLAM) technology. The use of 3D data will be described in more detail below.

As such, the stereo camera simultaneously acquires 2D and 3D data, thereby supporting both comparison with the reference database 10 and relative position estimation.

Accordingly, the accuracy and reliability of position estimation can be improved, particularly allowing for accurate position estimation even in complex environments.

The position estimation module 30 may include a similar image retriever 31, a transformation matrix calculator 32, and a position estimator 33.

The similar image retriever 31 is configured to compare the similarity between the real-time image acquired by the real-time data acquisition module 20 and the reference images stored in the reference database 10 to retrieve the most similar image. In other words, it provides the basis for calculating an accurate location as the starting step for position estimation.

For example, the similar image retriever 31 can use a template matching algorithm to calculate the degree of matching between the real-time image and the reference image. During this process, feature points of each reference image and the real-time image are compared, and the reference image with the highest degree of matching can be identified.

By retrieving the most similar reference image, the reliability of the initial input data for the position estimation process can be increased.

The transformation matrix calculator 32 is configured to calculate a transformation matrix based on the difference between the reference image retrieved by the similar image retriever 31 and the real-time image. The transformation matrix is a mathematical expression that precisely links the location of the real-time image to the location of the reference image, serving as core data for position estimation.

The transformation matrix calculator 32 can compare feature points of the real-time image and the reference image and calculate their relative position and rotation information, thereby generating a transformation matrix. Using the transformation matrix, it is possible to compensate for position and rotation differences between the real-time data and the reference data, allowing for a more accurate estimation of the current position.

The position estimator 33 is configured to finally calculate the current position information based on the data provided by the similar image retriever 31 and the transformation matrix calculator 32. During this process, the transformation matrix is applied to the location of the reference image to precisely estimate the real-time location. In other words, the transformation matrix provided by the transformation matrix calculator 32 is applied to the location information of the reference image to calculate the absolute coordinates of the tracked object from which the real-time data is acquired.

As described above, the similar image retriever 31 can retrieve the image most similar to the real-time image among the reference images by matching feature points between them.

Specifically, unique feature points (e.g., SIFT, SURF, ORB, etc.) are extracted from the real-time image and each reference image. These feature points may be defined as specific patterns, contours, corners, etc. within an image. Then, based on the extracted feature points, the degree of matching is calculated between the real-time image and each reference image. The degree of matching may be determined based on the distance or similarity between the feature points. Finally, the reference image with the highest degree of matching is selected, which can be used as initial data for position estimation.

The feature point matching algorithm accurately evaluates the similarity between images, enabling rapid retrieval of the most suitable reference image. Furthermore, by utilizing unique feature points, stable image matching is possible even under various conditions, such as lighting changes, rotation, and size changes.

Additionally, the similar image retriever 31 based on feature point matching can efficiently retrieve images within the reference database 10. Feature matching utilizes the structural information of the image, thereby providing high accuracy while reducing the amount of computation.

In another embodiment, the real-time position tracking system 1 according to the present disclosure may further include a SLAM position estimation module 40. In addition, the system may further include a position correction module 50 together with the SLAM position estimation module 40.

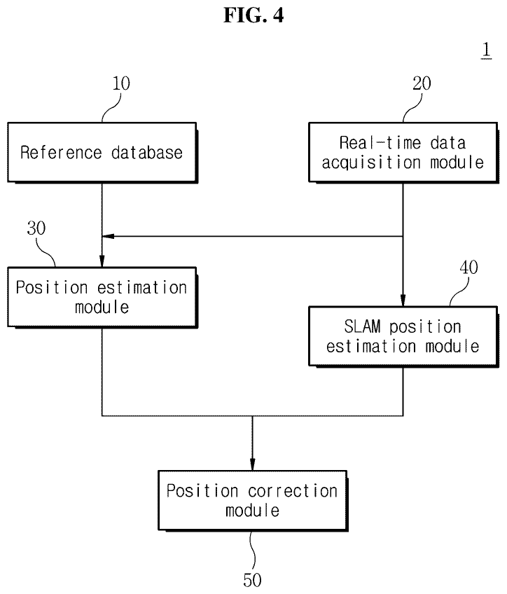

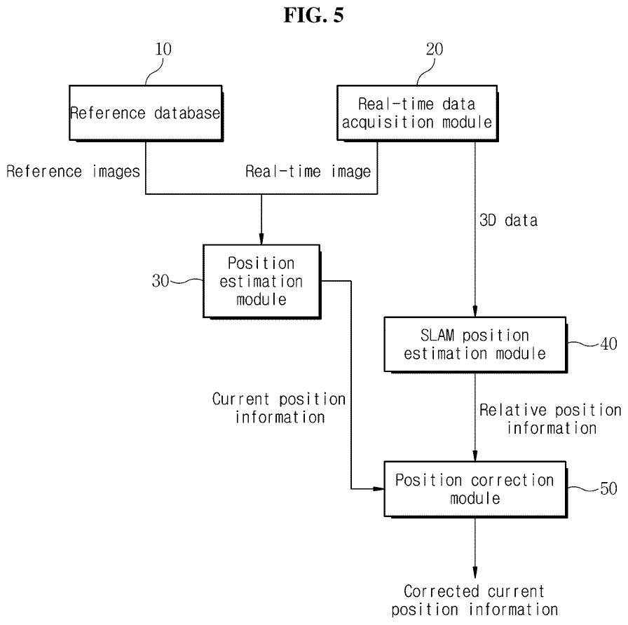

FIG. 4 is a schematic diagram of a real-time position tracking system according to another embodiment of the present disclosure, and FIG. 5 is a diagram illustrating the operation of a real-time position tracking system according to another embodiment of the present disclosure.

The SLAM position estimation module 40 is configured to generate an object's relative position and an environmental map in real time. It operates independently from the reference database 10 and can serve as an auxiliary tool for real-time position estimation.

Specifically, the SLAM position estimation module 40 calculates the relative coordinates of the object's movement from its starting position by utilizing 3D data among data collected by the real-time data acquisition module 20.

The relative position information generated by the SLAM position estimation module 40 can be used to correct the current position information calculated by the position estimation module 30, thereby enhancing the accuracy and reliability of position estimation.

To acquire relative position information using the SLAM technique, the real-time data acquisition module 20 may include an IMU sensor in addition to a stereo camera. The module can then calculate the direction and distance traveled by the object to generate relative coordinates.

The position correction module 50 is configured to correct the current position information calculated by the position estimation module 30 by utilizing the relative position information obtained from the SLAM position estimation module 40.

Specifically, the relative position provided by the SLAM position estimation module 40 is compared with the current position information calculated by the position estimation module 30. This comparison allows for analysis of inconsistencies or errors between the respective position information. Furthermore, if the inconsistency or error between the respective position information exceeds a certain value, the relative position information can be used to correct the current position information.

Correction of the current position information can be achieved more precisely by fusing the relative position information with the current position information.

As such, comparing and fusing the relative and absolute positions to correct the current position can improve the accuracy of the position estimation.

The position correction module 50 can correct the current position information through Kalman filtering. In general, Kalman filtering can fuse relative position information with current position information.

A Kalman filter is an algorithm used to estimate the state of a dynamic system. It fuses relative position information and current position information in real time, thereby adjusting for inconsistencies between data and accurately correcting the current position. Therefore, errors that may occur during the real-time position tracking process can be minimized.

In addition to the configuration described above, the real-time position tracking system 1 according to the present disclosure may further include a communication unit (not shown) for wired or wireless communication between respective components of the system 1 and with external entities, an input unit (not shown) for inputting an operation signal or a setting value to the system 1, a storage (not shown) for storing programs and setting values required for the operation of the system 1 and data generated during the operation of the system 1, a display (not shown) for displaying the operation status or results of the system 1, and a controller (not shown) for controlling respective components of the system 1.

Hereinafter, a real-time position tracking method according to the present disclosure will be described. While describing the real-time position tracking method, a detailed description of matters mentioned in the description of the real-time position tracking system 1 may be omitted.

FIG. 6 is a flowchart of a real-time position tracking method according to an embodiment of the present disclosure.

The real-time position tracking method may include a reference database creation step S10, a real-time data acquisition step S20, and a position estimation step S40.

In the reference database creation step S10, the system prepares reference data for a designated space to establish the basis for position estimation. Specifically, high-precision 3D scanning equipment (e.g., RTC360) is used to create 3D map data of the designated space. This data includes spatial structure and topographic information and is stored in the reference database 10. In addition, reference images are created using images captured at specified intervals (e.g., 1 m) and angles (e.g., 60-degree intervals). The captured images are stored in a lookup table format and can be used as reference data in the position estimation process.

In the real-time data acquisition step S20, the real-time data acquisition module 20 of the system collects data on the surrounding environment while an object moves within the designated space, thereby providing input values for position estimation. Specifically, images around the moving object are acquired in real time using a stereo camera. Furthermore, by utilizing an additional sensor such as IMU, information such as the rotation, velocity, and acceleration of the object can be collected simultaneously.

In the position estimation step S40, the position estimation module 30 of the system compares real-time data with the reference database 10 to calculate the current position of the object. Specifically, the module compares the real-time image with the reference images in the reference database 10, retrieves the most similar reference image, and analyzes the difference between the real-time image and the retrieved reference image to calculate a transformation matrix. The transformation matrix is then applied to the position of the retrieved reference image to estimate current position information.

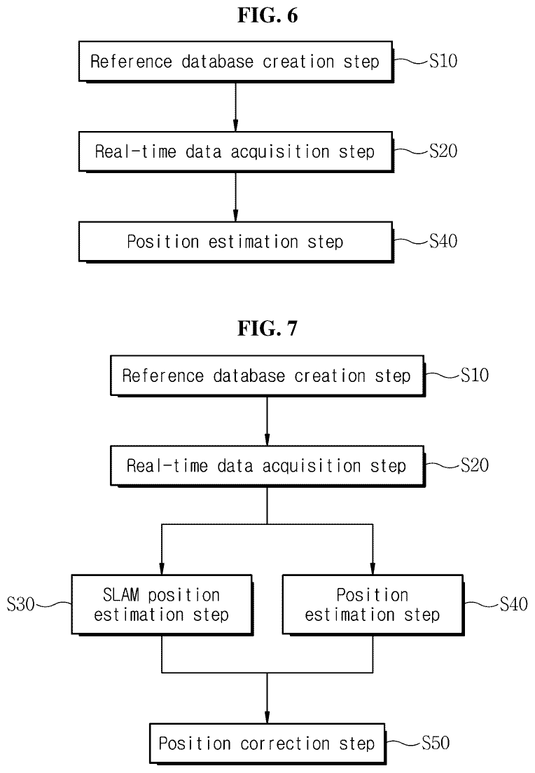

In another embodiment, the real-time position tracking method according to the present disclosure may further include a SLAM position estimation step S30 and a position correction step S50, as illustrated in FIG. 7.

In the SLAM position estimation step S30, the SLAM position estimation module 40 of the system calculates a relative position based on the starting position through the SLAM technique using the data acquired in the real-time data acquisition step S20. This SLAM position estimation step S30 may be performed between the real-time data acquisition step S20 and the position estimation step S40.

In the position correction step S50, the current position information estimated in the position estimation step S40 is corrected using the relative position information acquired in the SLAM position estimation step S30. Specifically, the current position information can be corrected by fusing the current position information and relative position information through Kalman filtering.

While the present disclosure has been particularly shown and described with reference to embodiments thereof, it will be understood by those skilled in the art that various changes in form and details may be made therein without departing from the scope of the present disclosure as defined by the appended claims.

Research related to the present disclosure was conducted as part of the project titled “Development of 3D Virtual Space and Dynamic Object Reconstruction Technology based on Multi-Image for Manufacturing Site Support” (Project ID: 2710007856, Grant No. 2022-0-00970), which is funded by the Ministry of Science and ICT (MSIT) and administered by the Institute of Information & Communications Technology Planning & Evaluation (IITP).

What is claimed is:

1. A real-time position tracking system comprising:
a reference database configured to store reference images captured at a plurality of locations within a designated space;
a real-time data acquisition module configured to acquire a real-time image while moving within the designated space; and
a position estimation module configured to estimate current position information by comparing the real-time image acquired by the real-time data acquisition module with the reference images stored in the reference database.

2. The system of claim 1, wherein the reference database further stores map data for the designated space.

3. The system of claim 2, wherein the map data is configured to be acquired through three-dimensional (3D) scanning.

4. The system of claim 1, wherein the reference images are configured to be captured from multiple angles at the plurality of locations with specified intervals within the designated space.

5. The system of claim 4, wherein the reference images are configured to be mapped respectively to the locations within the designated space and stored in a lookup table form.

6. The system of claim 1, wherein the real-time data acquisition module includes a stereo camera.

7. The system of claim 1, wherein the position estimation module comprises:
a similar image retriever configured to retrieve an image most similar to the real-time image among the reference images;
a transformation matrix calculator configured to calculate a transformation matrix based on a difference between the reference image retrieved by the similar image retriever and the real-time image; and
a position estimator configured to estimate the current position information by applying the transformation matrix to a position of the reference image retrieved by the similar image retriever.

8. The system of claim 7, wherein the similar image retriever is configured to match feature points of the real-time image and each reference image to retrieve the image most similar to the real-time image among the reference images.

9. The system of claim 1, further comprising:
a simultaneous localization and mapping (SLAM) position estimation module configured to acquire relative position information through SLAM technique using data acquired from the real-time data acquisition module.

10. The system of claim 9, further comprising:
a position correction module configured to correct the current position information estimated by the position estimation module, using the relative position information acquired by the SLAM position estimation module.

11. The system of claim 10, wherein the position correction module is configured to correct the current position information through Kalman filtering.

12. A real-time position tracking method comprising:
creating and storing reference images captured at a plurality of locations within a designated space;
by a real-time data acquisition module, acquiring a real-time image while moving within the designated space; and
by a position estimation module, estimating current position information by comparing the acquired real-time image with the created and stored reference images.
